(19) United States
(12) Patent Application Publication
(10) Pub. No.: US 2013/0119028 A1
(43) Pub. Date: May 16, 2013

(54) DEVICE FOR PROCESSING PIPES BY MEANS OF A LASER BEAM

(71) Applicants: Alexander Kuhn, Herisau (CH); Christoph Deininger, Reutlingen (DE)

(72) Inventors: Alexander Kuhn, Herisau (CH); Christoph Deininger, Reutlingen (DE)

(21) Appl. No.: 13/811,480

(22) PCT Filed: Jul. 15, 2011
(86) PCT No.: PCT/EP2011/003531

§ 371 Date: Jan. 22, 2013

(30) Foreign Application Priority Data
Jul. 19, 2010 (DE) 10 2010 027 638.3

(51) Int. Cl. B23K 26/02

(52) U.S. Cl. CPC B23K 26/02
USPC 219/121.82

(57) ABSTRACT

The invention relates to a device for processing pipes or other elongated materials (6) by means of a laser beam (8) produced by a laser beam source (7), comprising a retaining element for retaining a tool or cutting element, wherein said retaining element is mounted so as to be slidable and rotatable relative to a machine bed (1). The material (6) to be processed passes through an opening (5) surrounded by the retaining element. Favorable and flexible processing of widely varying materials is enabled in that the rotatably and slidably mounted retaining element is an elongated rotational element, on the inside of which the laser beam source (7) for the laser beam (8) is arranged as the tool or cutting element.

### CROSS REFERENCE TO RELATED APPLICATIONS

The present application claims priority from German patent application 10 2010 027 638.3, filed 19 Jul. 2010, the disclosure content of which is hereby also expressly incorporated by reference in its entirety as subject matter of the present application.

### TECHNICAL FIELD OF THE INVENTION

The invention relates to a device for processing pipes or other elongate materials by means of a laser beam, generated by a laser beam source.

### BACKGROUND OF THE INVENTION

If a pipe needs to be machined or cut, it is generally mounted in the chuck of a lathe, held firmly thereby and rotated, while a non-rotating cutting tool is moved from the side into the rotating pipe, for example. Cutting is accomplished in a plurality of successive rotations of the pipe, while the tool applied thereto gradually penetrates into the rotating pipe. A heavy bed is necessary for the lathe, this being fixed permanently in one place. In addition, rigid but mobile holders are needed for the tool to be applied.

To simplify machining, such as for example cutting operations, lasers are used. Reshaping of pipes by means of laser machining proceeds in conventional installations by means of a stationary laser or one displaceable in linear manner, underneath which the pipe to be machined is turned or displaced. In the case of long pipes which already comprise bends or angles or of pipes already connected with other components, it is often impossible or possible only with great difficulty to rotate the workpiece, such that other machining or cutting methods have to be used.

DE 11 2007 001 639 T5, which forms the basis of the preamble of claim 1, discloses a pipe cutting device in the center of which is provided a central opening, in which the material or pipe to be cut is immobilized. A cutting head is guided around this central opening, said head being rotatable and movable in the longitudinal direction of the material to be cut. Two different drives are coordinated by means of a processor, so that even complex cutting operations can be performed. The cutting head is at a distance from the stationary laser beam source, such that the laser light still has first to be fed to the cutting head. This has to be ensured even when the cutting head is rotating. Since the central opening has to be adapted to the diameter of the pipe, the range of application is dependent on the size of the central opening.

### BRIEF SUMMARY

Taking this prior art as basis, the invention provides a device for processing pipes or other elongate materials by laser beam, which allows favorable and flexible machining of the most different range of materials.

A preferably central opening is also provided in this device, but said opening does not serve to fix the pipe, but rather merely to accommodate said pipe. In addition, this central opening is formed in an elongate rotational body such as for example a drum, so giving rise to a tunnel within which machining may proceed. There are thus no limitations as regards the length of the operations to be performed. The opening may in this case be of such a size that both very small and very large diameters or geometries may be machined. Since the laser beam source is already arranged in the elongate rotational body, all that remains to be provided is a suitable energy supply and appropriate control, which may preferably proceed by way of rotary feedthrough units or slip rings, in order to introduce the corresponding power and control commands into the elongate rotational body. As a result of flexible accommodation of the material to be machined, the possible geometries and rotational movements are determined by the relative motion of rotational body and pipe, such that faster machining cycles are also possible which exploit the maximum power of the laser beam.

Further advantages arise from the subclaims and the following description of a preferred exemplary embodiment.

### BRIEF DESCRIPTION OF THE DRAWINGS

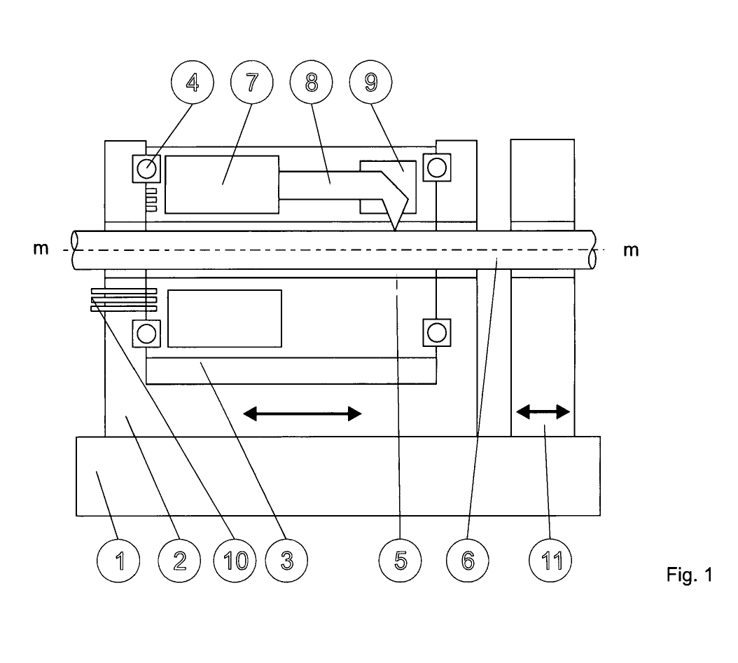

The single FIG. 1 shows a schematic, sectional representation of the device with a laser beam source arranged in a drum.

### DETAILED DESCRIPTION OF PREFERRED EMBODIMENTS

The invention will now be explained in greater detail by way of example with reference to the appended drawings. However, the exemplary embodiments are merely examples, and are not intended to restrict the inventive concept to a specific arrangement. Before the invention is described in detail, it should be pointed out that it is not limited to the particular components of the device and the particular method steps, since these components and methods may vary. The terms used herein are merely intended to describe particular embodiments and are not used in a limiting manner. In addition, where the description or the claims uses the singular or indefinite article, this also covers a plurality of said elements, providing that the overall context does not unambiguously indicate otherwise.

FIG. 1 is a schematic diagram of a device for processing pipes or other elongate materials 6, wherein these pipes and materials may have different cross sections and different diameters and geometries. Machining is performed by means of a laser beam 8 generated by a laser source 7, all machining processes which can be carried out with laser beam sources being possible. In particular, laser processes are provided for cutting, separating, marking, cleaning, joining, abrading, hardening or labeling of materials or indeed for stripping wires.

The laser beam 8 may in this case pass in any desired manner from the laser beam source 7 to the machining point on the material 6 to be machined. The Figure shows a free laser beam 8 and a beam-guiding and/or beam-shaping element 9 in the form of a deflecting element. The beam could, however, be guided just as well for example by a fiber or a waveguide or the like. The expression “beam-guiding and/or beam-shaping element” 9 is understood to cover all laser beam-guiding elements, such as fibers, mirrors, toroids, deflectors, beam splitters, scanners etc., and/or laser beam-shaping elements, such as for example lenses or indeed combined elements such as for example focusing mirrors, adaptive mirrors etc.

On a machine bed 1 there is provided a holding element, mounted so as to be displaceable relative to said machine bed and rotatable, for holding a tool or cutting means. This holding element is formed by an elongate rotational body, which in the exemplary embodiment takes the form of a drum 3. However, the elongate rotational body may exhibit any desired external geometry and/or internal geometry in which a tunnel is formed in the longitudinal direction for accommodating the material to be machined. In the further explanation of the invention, the holding element or the elongate rotational body is designated as drum 3.

The holding element or the drum 3 surrounds a central, in this respect tunnel-like opening 5, through which the material 6 to be machined passes during machining. In principle, a non-central opening is also feasible, provided that the desired machining is ensured. As it can be seen clearly, the material 6 is not fixed in the central opening 5, but rather is accommodated freely therein. It goes without saying that the material or the pipe must be held for this purpose at another point, such as for example on a mount or a robot arm, at least such that it can, as required, be moved in the longitudinal direction or rotated about its center axis m-m. Pipes or materials which are already connected to other elements or also already bent can also be machined. In addition, the material can be supplied to the device both in pieces which have been cut to length and also continuously.

The laser beam source 7 is arranged on the inside in the drum 3. The laser beam source must to this end be contacted from outside, for which purpose rotary feedthrough units 10 are provided which not only supply power but also feed and remove media and also enable a connection to a processor (not shown), for example for sending control commands to the laser beam source. The microprocessor, not shown in the drawings, is moreover connected to the drive unit via the bearing blocks 2, 11, both of which are displaceable relative to the machine bed 1 in the longitudinal direction of the material to be machined, in accordance with the arrows shown in FIG. 1. The microprocessor likewise controls the rotary drives, not shown in the drawings, for the drum 3 and/or the material 6 to be machined.

On the bearing block 2 which is displaceable in the longitudinal direction, the driven drum 3, which is mounted rotatably about the center axis m-m, is supported by a suitable bearing 4 relative to the bearing block 2. Suitable material 6 of any desired cross section can be supplied, cut to length or alternatively also continuously, to the central opening 5. The material 6 can rotate about the center axis m-m or be guided rigidly and it can also be moved in the longitudinal direction or be fixed to the machine bed 1. In the drum 3, a suitable tool, in particular a laser beam source 7, is arranged such that machining takes place on the circumference of the workpiece by rotating the drum 3. In the case of a laser beam, a suitable beam-guiding and/or beam-shaping element 9 deflects the beam towards the workpiece at a suitable angle. The laser beam source 7 thus emits the beam substantially parallel to the center axis m-m, such that the beam-guiding and/or beam-shaping element 9 deflects the laser beam onto the material 6 to be cut in the drum 3. Any other arrangement of the laser beam source 7 is, however, conceivable in principle, providing that the laser beam source 7 is arranged within the drum 3. Accordingly, the laser beam source can for example also be oriented radially towards the machining point without requiring a beam-guiding and/or beam-shaping element 9. The beam-guiding and/or beam-shaping element 9 and/or also the laser beam source may constructed so as also to be radially and/or axially adjustable with regard to the drum by means of a drive, not shown in the drawings, in order to adjust the laser beam focal point to different and/or non-rotationally symmetrical or asymmetrical geometries.

A further bearing block 11, which is movable in the longitudinal direction of the material 6 to be machined, assists material handling. The relative motion between material 6 and drum 3 is determined by the advance of the material 6 and the movement of the bearing block 2. The relative speed of the tool or the laser beam source 7 to the material at the circumference is determined by the speed of rotation of the drum 3 and material 6.

The tunnel formed by the central opening 5 in the drum 3 permits versatile machining of the material 6 to be machined. On the one hand, any desired small or also large diameter may be used, provided that the central opening 5 is sufficiently large in diameter. On the other hand, no optical systems for the laser beam disrupt machining within the central opening. The drum 3 additionally has the advantage that relatively long cuts or machined portions can be made in the longitudinal direction of the material, it being possible to lengthen the drum correspondingly if required.

It goes without saying that the present description may be subjected to the most varied modifications, changes and adaptations which are of the nature of equivalents to the appended claims.

1. A device for processing pipes or other elongate materials by means of a laser beam generated by a laser beam source, comprising
a machine bed,
a holding element, mounted so as to be displaceable relative to said machine bed and rotatable, for holding a tool or cutting means,
an opening surrounded by the holding element, through which opening the material to be machined passes during processing,
wherein the rotatably and displaceably mounted holding element is an elongate, hollow rotational body, on which the laser beam source for the laser beam is arranged on the inside as the tool or the cutting means.

2. A device according to claim 1, wherein a tunnel for accommodating the material to be machined is provided in the longitudinal direction in the elongate, hollow rotational body.

3. A device according to claim 1, wherein the elongate, hollow rotational body is a drum, the opening being a central opening of the drum.

4. A device according to claim 1, wherein the laser beam is supplied freely to the material to be machined.

5. A device according to claim 1, wherein the elongate, hollow rotational body is mounted rotatably about the center axis of the material to be machined on a bearing block, which is arranged displaceably relative to the machine bed in the longitudinal direction of the material to be machined.

6. A device according to claim 1, wherein the material passes through the opening at least one of movably in the longitudinal direction and/or rotatably about its center axis (m-m).

7. A device according to claim 1, wherein the laser beam source emits the laser beam substantially in the direction of the center axis (m-m) and in that there is provided in the drum at least one of a beam-guiding or beam-shaping element for deflecting the laser beam onto the material to be machined.

8. A device according to claim 7, wherein the at least one of the beam-guiding or beam-shaping element is at least one of radially or axially adjustable with regard to the center axis of the drum.

9. A device according to claim 7, wherein the at least one of the beam-guiding or beam-shaping element comprises at least one of the elements from the group of adaptive mirrors, focusing mirrors, toroids, scanners, fibers, deflection elements, beam splitters or lenses.

10. A device according to claim 5, wherein rotary feedthrough units are provided between the elongate, hollow rotational body and the bearing block for supplying power to the laser beam source.

11. A device according to claim 1, wherein a further bearing block is provided which is displaceable on the machine bed in the longitudinal direction of the material to be machined.

12. A device according to claim 1, wherein the laser beam is guided by fibers or waveguides to the material to be machined.
